(19) United States
(12) Patent Application Publication
(10) Pub. No.: US 2018/0294451 A1
(43) Pub. Date: Oct. 11, 2018

(54) BATTERY MODULE COMPRISING A HIGH-CURRENT SPRING CONTACT

(71) Applicant: Robert Bosch GmbH, Stuttgart (DE)

(72) Inventors: Matthias Oechsle, Ditzingen-Hirschlanden (DE); Moritz Pickhardt, Stuttgart (DE)

(21) Appl. No.: 15/946,046

(22) Filed: Apr. 5, 2018

(30) Foreign Application Priority Data
Apr. 5, 2017 (DE) 10 2017 205 774.2

(51) Int. Cl. H01M 2/10; H01M 2/20

(52) U.S. Cl. CPC H01M 2/1077; H01M 2220/20; H01M 2/206

(57) ABSTRACT

A battery module (10) having a module housing (10.1) and a plurality of battery cells (11) which are arranged in parallel in the module housing (10.1), wherein at least two battery cells (11) are mechanically mounted on the module housing (10.1) in each case by at least one bearing element (13) and two battery cells (11) which are arranged adjacent to one another are electrically connected to one another by at least one high-current spring contact (12).

### BACKGROUND OF THE INVENTION

The present invention relates to a battery module and also to a battery, in particular for a vehicle which can be at least electrically driven.

Document DE 10 2014 212 271 A1 discloses a connecting element for electrically connecting battery cells and/or battery modules, wherein the connecting element has a connection region for connection to a terminal and a receptacle region for releasable connection of a connector, and wherein a spring element is provided for the purpose of establishing an electrically conductive connection with the terminal.

### SUMMARY OF THE INVENTION

A first aspect of the invention claims a battery module, wherein the battery module has a module housing and a plurality of battery cells which are arranged in parallel in the module housing. According to the invention, at least two battery cells are mechanically mounted on the module housing in each case by means of at least one bearing element and two battery cells which are arranged adjacent to one another in the module housing are electrically connected to one another, in particular connected electrically in series, by means of at least one high-current spring contact. According to the invention, the high-current spring contact between two battery cells which are arranged adjacent to one another is therefore of resilient (flexible) design. The high-current path is therefore produced only by means of lining up the battery cells geometrically in parallel in relation to one another. The electrical connection of the battery cells is therefore physically separate from the mechanical mounting of the battery cells in the module housing. Accordingly, the bearing element serves solely to mechanically mount the battery cell in the module housing and the high-current spring contact serves solely to electrically connect two adjacent battery cells. The physical and functional separation prevents the bearing element from serving to make electrical contact with the battery cells and/or prevents the high-current spring contact from serving to mechanically mount the battery cells. Therefore, a fracture or breakdown in the bearing element does not automatically lead to an electrical breakdown of the battery module. In this case, the high-current spring contact is of electrically conductive design, in particular the high-current spring contact is designed in such a way that a low contact resistance can be produced, so that the high-current path has a low resistance value. Furthermore, it may be advantageous to geometrically and/or chemically design the high-current spring contact (for example by alloys or coatings) in such a way that said high-current spring contact is not susceptible to contact corrosion, abrasion or oxidation in the electrical contact region of the two battery cells.

The design according to the invention of the battery module, in particular the independent sole electrical and also the sole mechanical connection of the battery cells within the module housing makes it possible for the cells to have to be inserted only into the module housing of the battery module. Furthermore, the configuration according to the invention has the advantage that component and/or positioning tolerances between the battery cells and/or in the module housing can be compensated for. Furthermore, the battery cells of the battery module in the module housing can be easily exchanged. In addition, good scalability of the battery module can be achieved by the mechanical connection of the battery cells in the module housing being formed independently of the electrical connection of the two battery cells, which are adjacent to one another, in the module housing. According to the invention, the high-current spring contact is of elastic design, so that a spring force is exerted between the two battery cells which are electrically connected to one another. Therefore, the electrical connection of the two battery cells can also be ensured in the event of vibrations.

In order that a sufficient amount of electrical energy can be transmitted between the battery cells, the high-current spring contact is preferably designed with a (minimum) cross section which is between approximately 5 mm² and approximately 25 mm², preferably between approximately 7 mm² and approximately 12 mm², particularly preferably between approximately 8.5 mm² and approximately 10.5 mm². In addition, it is feasible for the high-current spring contact to have a specific resistance of 0.005 to 0.2 μΩ*m, preferably between 0.015 and 0.04μΩ*m in order to create low-energy losses. In order that only low power losses are produced at the high-current spring contact, said high-current spring contact can be designed with an adequate cross section in accordance with the requirements. To this end, the present invention allows any desired scalability of the high-current spring contact since said high-current spring contact can be constructed from individual, geometrically identical elements. Conventional cross sections for traction batteries can lie in the range of from 5 mm² to 20 mm². Given a specific resistance of usable materials of approximately 25% IACS to 63% IACS, it is hereby possible to create electrical connections of which the transfer resistance is less than 1/10 of the internal resistance of the cell.

Further features and details of the invention can be found in the dependent claims, the description and the drawings. In this case, it goes without saying that features and details which have been described in connection with the apparatus according to the invention comprising the battery module according to the invention also apply in connection with the battery according to the invention and vice versa in each case, with the result that reference is or can be always reciprocally made with respect to the disclosure relating to the individual aspects of the invention.

According to the invention, it may be advantageous that the bearing element is in the form of a fixed bearing, wherein each battery cell is separately mechanically fixed to the module housing by means of in each case at least one fixed bearing. Here, individual fixing of the battery cells in the module housing can be established, so that no force transmission or substantially no force transmission between the two battery cells which are electrically connected to one another is possible. The fixed bearings in the battery module are preferably arranged on the module housing in such a way that a clearance can be produced between the battery cells. The inertia force or inertia mass in the fixed bearing is therefore in each case always only the inertia force accordingly generated by the individual battery cell. In this case, the clearance between the battery cells which are at least electrically connected to one another is preferably dimensioned in such a way that the high-current spring contact can establish a continuous electrical connection between the two battery cells which are arranged adjacent to one another. According to the invention, the high-current spring contact can be designed in such a way that component and positioning tolerances in the horizontal and/or vertical direction between the battery cells can be compensated for. The fixed bearing can preferably be connected to the module housing on a broad side of the battery cell. In this case, the connection can be formed in a force-fitting manner and/or interlocking manner and/or with the same material. In this case, the bearing element which is in the form of a fixed bearing can be designed to be screwed, welded, riveted or adhesively bonded to the module housing or can be formed from the module housing. The connection of the fixed bearing to the battery cell can also be formed in a force-fitting manner, interlocking manner and/or with the same material. The battery cell is preferably electrically insulated from the module housing and/or thermally connected to the module housing. Therefore, simple installation of the respective battery cell into the battery module is also possible.

Furthermore, it is feasible that the bearing element is in the form of a spring element, wherein, in particular, a cell receptacle is provided, in which cell receptacle the battery cells are arranged in parallel in relation to one another and the cell receptacle is mechanically connected to the module housing by means of at least one spring element. A plurality of cells can be arranged, in particular, in parallel in relation to one another by means of the cell receptacle according to the invention, so that a cell stack is produced and the battery cells which are arranged in the cell receptacle are pressed together by the spring element. A transmission of force can be established between the cells here too. Accordingly, the battery cells can be lined up with one another without gaps, as a result of which the electrical connection is formed by means of the high-current spring contact in a more fail-safe manner with respect to component and/or positioning tolerances. The bearing element can be arranged only at the outermost battery cells in the module housing and/or positioned between the battery cells which are arranged adjacent to one another. When a cell receptacle is used, the bearing element is arranged between the cell receptacle and the module housing. According to the invention, it is feasible that the spring element is formed from the module housing or from the cell receptacle. Furthermore, a separate spring element can be arranged between the cell receptacle and the module housing. A plurality of spring elements can also be arranged between the battery cells and/or between the cell receptacle and the module housing and/or between the battery cells and the module housing. In this case, the spring element is preferably dimensioned in such a way that the inertia forces between the battery cells can be absorbed, so that mechanical damage to the battery cells can be suppressed. The transmission of force as a result of the inertia forces in the event of a load is usually between approximately 10 N and 20 kN. The cell receptacle is preferably designed in an electrically insulating manner in relation to the module housing and/or to the battery cell and/or is thermally connected.

It may be advantageous that that the high-current spring contact is arranged on at least one longitudinal side and/or one broad side of the battery cell. According to the invention, the longitudinal side or longitudinal face of the battery cell is intended in this case to define the face which is formed between the battery cells which are arranged in parallel in relation to one another. An arrangement of the high-current spring contact on the broad side of the battery cells allows component and/or positioning tolerance compensation in, in particular, the orthogonal direction. If the spring contact is arranged on a longitudinal side of the battery cell, compensation of the component and/or positioning tolerances in the horizontal direction is possible.

According to the invention, it is feasible that the high-current spring contact is cohesively and electrically conductively connected to the battery cell, wherein, in particular, the spring contact is formed, at least in sections, from a terminal of the battery cell. In this case, a terminal of the battery cell can also be understood to mean a pole and/or a connection lug of the battery cell within the meaning of the present invention. According to the invention, a cohesive and electrically conductive connection of a high-current spring contact to the battery cell can be of, for example, bonded, electrically conductively connected, welded and/or soldered design. It is feasible that the spring contact is connected to the battery cell, in particular to the terminal/pole of the battery cell, by means of ultrasonic welding, laser welding or resistance welding. As a result, the resistance path between the two battery cells which are electrically connected to one another can be reduced. In this case, the high-current spring contact can be formed, for example, from a stamped metal sheet. This allows cost-effective and simple production and simple installation of the battery cells into the battery module. It is also feasible that the high-current spring contact is formed from the battery cell.

It may be advantageous when at least one (mechanical) spacer is arranged between the battery cells, wherein, in particular, the spacer is formed from the cell housing of the battery cell. According to the invention, a spacer can also be understood to mean a spacer between at least two battery cells. The spacer according to the invention allows “the cells to breathe” (geometric change in the cell), in particular in the region of the battery cell which is formed between the spacers or adjacent to the spacer.

The spacer can preferably be of rigid design. It is feasible that the spacer is formed from a plastic or a ceramic, so that electrically insulating contact can be established between the battery cells which are at a parallel distance from one another. The breathing, which can also be called swelling of the battery cell, can be produced over the life cycle of the battery cell, for example, during charging of the battery cell. In this case, the bearing element is preferably arranged on the outer sides of the longitudinal face of the battery cell. In particular, the region in the middle of the longitudinal face or longitudinal side of the battery cell is affected by breathing or swelling processes of the battery cell. The region between at least two spacers on a battery cell or adjacent to the spacer therefore allows swelling between the battery cells which are arranged in relation to one another in a defined manner. Furthermore, it is feasible that the spacer is formed from the cell housing of the battery cell. In this case, the spacer can be fixed to the battery cell or inserted subsequently. According to the invention, the spacer can be dimensioned in such a way that a distance between at least two battery cells is between 0.5 mm and 50 mm, preferably between 5 mm and approximately 25 mm, particularly preferably between 10 mm and approximately 20 mm.

Furthermore, it is feasible that the spring contact has a contact area which is of substantially punctiform design. In this case, punctiform means a contact face which is of convex or protruding design and allows electrical contact to be made between two battery cells, which are arranged at a distance from one another, in the module housing. The resistance path between the two battery cells which are electrically connected to one another is reduced by means of the punctiform contact face.

According to the invention, it is feasible that the spring contact is of at least lamellar, annular, disk-like, spiral or linear design. If the high-current spring contact is of lamellar design, a comb-like, resilient electrical connection can form between two battery cells. In this case, the lamellae are preferably designed in such a way that a spring force can be produced between two battery cells. According to the invention, there may also be a leaf spring between at least two battery cells as the high-current spring contact. Furthermore, it is feasible that a spring-mounted contact pin is arranged in a housing, wherein the housing is arranged on at least one battery cell, so that the spring-mounted contact pin is arranged in a resilient manner in the housing and can establish an electrical connection to an adjacent battery cell. Furthermore, it is feasible that the spring contact has a large number of contact points. In particular, the spring contact can be of comb-like design and have a large number of contact fingers. The spring contact preferably has between 1 and 20, particularly preferably between 5 and 18 contact points.

The spring contact can advantageously contain at least tin, nickel, gold, silver, copper and/or aluminum. It is also feasible that the spring contact contains bronze, nickel-phosphorus, gold-cobalt or silver-antimony. In particular, bronze, nickel-phosphorus, gold-cobalt or silver-antimony have a high resistance to friction corrosion. Gold, silver, silver-antimony or gold-cobalt have a very low resistance value, and therefore electrical energy can be transmitted between two battery cells without losses as far as possible.

A second aspect of the invention claims a battery, wherein the battery is designed, in particular, for a vehicle which can be at least electrically driven, and has a plurality of battery modules, which are at least electrically connected to one another, according to the invention. Accordingly, all of the advantages and features as have already been described in connection with the battery module according to the invention apply for the battery according to the invention.

Further measures which improve the invention result from the following description relating to some exemplary embodiments of the invention which are schematically illustrated in the figures. All of the features and/or advantages which are apparent from the claims, the description or the drawings, including structural details and spatial arrangements, can be essential to the invention both on their own and also in an extremely wide variety of combinations. It should be noted here that the figures are merely descriptive and are not intended to limit the invention in any way.

### BRIEF DESCRIPTION OF THE DRAWINGS

In the following figures, identical reference symbols are used for the same technical features, even of different exemplary embodiments.

In the figures:

FIG. 1 shows a first possible embodiment of a battery module according to the invention,

FIG. 2 shows a further possible embodiment of a battery module according to the invention,

FIG. 3 shows a further possible embodiment of a battery module according to the invention,

FIG. 4 shows a further possible embodiment of a battery module according to the invention,

FIG. 5 shows a further possible embodiment of a battery module according to the invention, and

FIG. 6 shows a possible embodiment of a high-current spring contact according to the invention.

### DETAILED DESCRIPTION

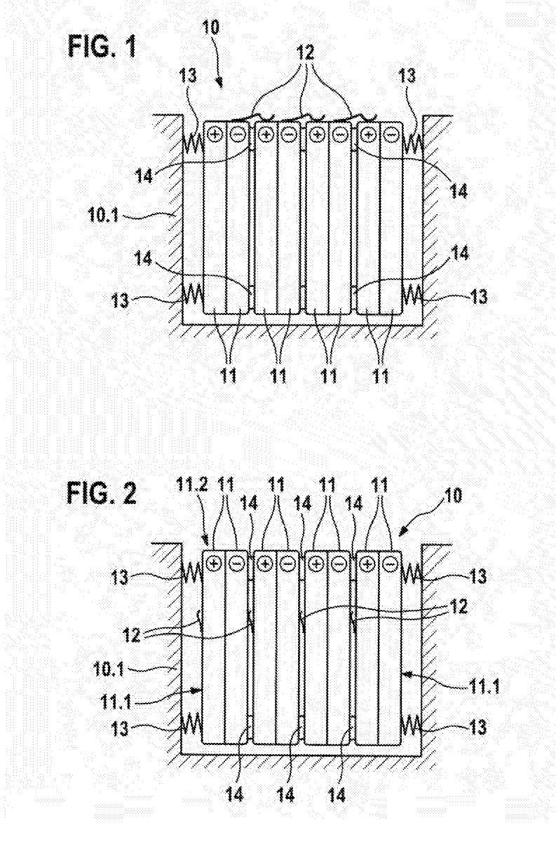

FIG. 1 schematically shows a battery module 10 according to the invention, wherein the battery module 10 has a module housing 10.1 in which a plurality of battery cells 11 (four battery cells 11 in FIG. 1) arranged in parallel in the module housing 10.1 are shown. At least two battery cells 11 are mechanically mounted on the module housing 10.1 in each case by means of a bearing element 13. In FIG. 1, the two outermost battery cells 11 of the battery module 10 are mechanically mounted on the module housing 10.1 by way of a bearing element 13 according to the invention. In this case, the bearing elements 13 are in the form of a spring element, so that the bearing elements 13 transmit a spring force to the battery cells 11, so that the battery cells 11 are pressed together. According to FIG. 1, the battery cells 11 are mounted in the module housing 10.1 in a resilient manner. Two battery cells 11 which are arranged adjacent to one another are electrically connected to one another by means of at least one high-current spring contact 12. In this case, the electrical high-current spring contact 12 is arranged on a broad side 11.2 of the battery cell 11 in FIG. 1. In FIG. 1, the high-current spring contact 12 allows, in particular, component and positioning tolerance compensation in the orthogonal direction. The bearing elements 13 allow force absorption, component and positioning tolerance compensation in the orthogonal and axial/horizontal direction. Accordingly, inertia forces of the battery cells 11 can be absorbed by the bearing elements 13 which are in the form of a spring element. According to the invention, the bearing element 13 can also be in the form of a spring/shock absorber combination. The battery cells 11 in FIG. 1 are connected to one another in the form of a cell stack by means of the bearing elements 13. Two spacers 14 are arranged between in each case two battery cells 11, so that a defined distance is established between two battery cells 11 which are arranged adjacent to one another. This allows the cells to breathe within the module housing 10.1 of the battery module 10.

FIG. 2 shows a further possible embodiment of a battery module 10 according to the invention. A total of four battery cells 11 are arranged adjacent to one another in the module housing 10.1 of the battery module 10. In contrast to the embodiment in FIG. 1, the high-current spring contact 12 in FIG. 2 is arranged on a longitudinal side/longitudinal face of the battery cells 11. The further features of the embodiment of the battery module 10 in FIG. 2 are identical to the embodiment in FIG. 1.

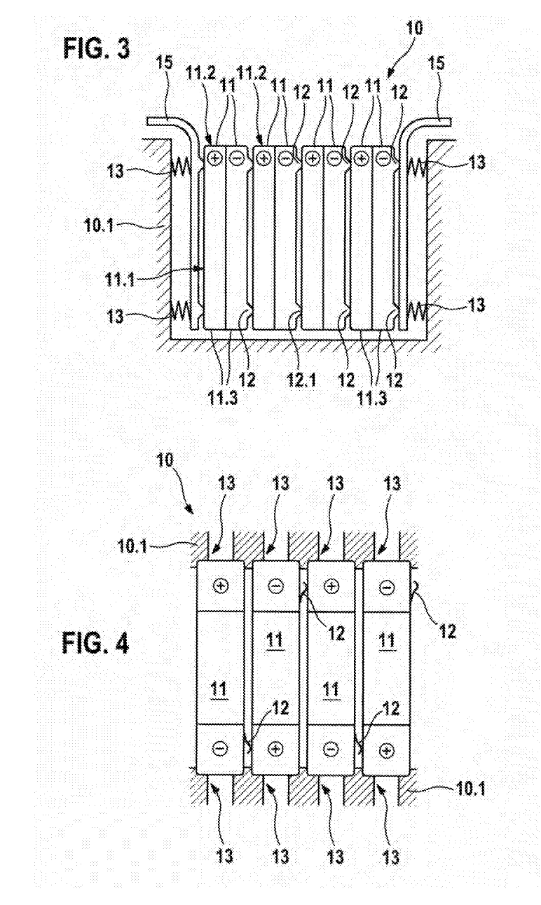

FIG. 3 shows a further possible embodiment of a battery module 10 according to the invention having a cell receptacle 15 in which a total of four battery cells 11 are arranged adjacent to one another. In this case, the cell receptacle 15 is mounted on the module housing 10.1 by means of a bearing element 13. FIG. 3 shows in each case two bearing elements 13 on the outermost longitudinal face 11.1 of the battery cells 11. The bearing elements 13 and the cell receptacle 15 mechanically press the battery cells 11 together in such a way that a cell stack is produced by two battery cells 11 which are arranged adjacent to one another being electrically connected to one another by means of at least one high-current spring contact 12. In FIG. 3, the high-current spring contact 12 is formed from a portion of the cell housing 11.3. At the same time, the high-current spring contact permits the function of a spacer 14 between two battery cells 11 which are arranged adjacent to one another, so that the battery cells 11 can breathe. The high-current spring contact 12 allows a punctiform contact face 12.1 between the battery cells 11, so that the resistance path for transmitting electrical energy between the battery cells 11 can be kept low. The cell housing 11.3 of the battery cells 11 in FIG. 3 accordingly has elastic/resilient properties, so that a resilient high-current spring contact 12 can be formed from the cell housing 11.3 of the battery cell 11. The high-current spring contact 12 which protrudes out of the cell housing 11.3/is of convex design is therefore of electrically conductive design and is in contact with a pole/contact face 12.1 of the adjacent battery cell 11.

FIG. 4 shows a further possible embodiment of a battery module 10 according to the invention, wherein the battery module 10 has a module housing 10.1 in which four battery cells 11 are arranged. In this case, each battery cell 11 is connected to the module housing 10.1 by means of fixed bearings 13. The fixed bearings 13 are formed from the module housing 10.1. The fixed bearing 13 is arranged on the broad side 11.2 of the battery cell 11, wherein in each case two fixed bearings 13 are arranged on a broad side 11.2 of a battery cell 11. A high-current spring contact 12 is formed on a longitudinal face in the region of the cell terminal/pole, so that an electrically conductive connection can be established between two battery cells 11 which are arranged next to one another. The embodiments of FIG. 4 and of FIG. 6 allow individual fixing of the battery cells 11. Therefore, there is no force transmission or substantially no force transmission between two battery cells 11 which are arranged adjacent to one another. Furthermore, a clearance can be produced between two battery cells 11, so that the battery cells 11 can breathe. Therefore, only the inertia mass of only one battery cell 11 is transmitted to the module housing 10.1. Transmission of the inertia force between the individual battery cells 11 is therefore substantially suppressed.

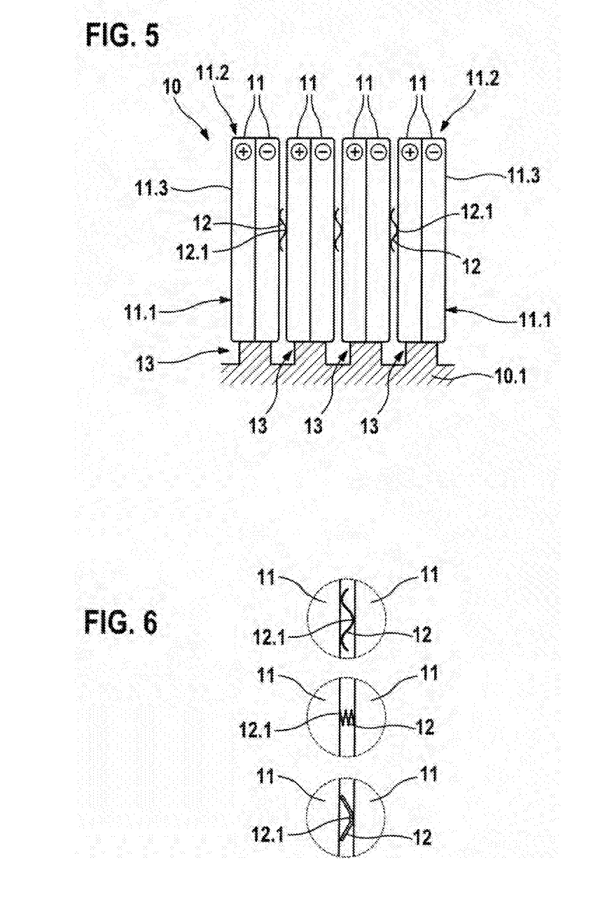

FIG. 5 shows a further embodiment of the battery module 10 according to the invention. In FIG. 5, the battery module 10 has four battery cells 11, wherein the battery cells 11 are connected to the module housing 10.1 by means of a fixed bearing 13. A high-current spring contact 12 is arranged on the longitudinal face 11.1 of the battery cells 11, wherein the high-current spring contact 12 has a substantially punctiform contact point 12.1. In each case one fixed bearing 13 fixes a battery cell 11 to the module housing 10.1. In this case, the fixed bearing 13 is arranged on a broad side 11.2 of the battery cells 11, so that the battery cells 11 are individually fixed in the module housing 10.1.

FIG. 6 shows possible embodiments of high-current spring contacts 12. In a first exemplary embodiment from FIG. 6, the high-current spring contact 12 is of lamellar/corrugated design and is arranged between the battery cells 11. A high-current spring contact 12 according to the invention can be arranged between the battery cells 11 before installation or subsequently. The high-current spring contact 12 of lamellar design has in each case punctiform contact faces 12.1 between the battery cells 11. In FIG. 6, the first embodiment of the high-current spring contact 12 has a total of three contact points 12.1 between the battery cells 11. The second embodiment from FIG. 6 of a high-current spring contact 12 according to the invention is in the form of a helical spring 12 and has a corresponding contact face 12.1 to the battery cells 11. A high-current spring contact element which is in the form of a helical spring allows component and positioning tolerance compensation in the orthogonal and horizontal direction. The third embodiment of a high-current spring contact 12 according to the invention in FIG. 6 exhibits a disk-like design, wherein a disk 12 of convex design forms a punctiform contact area 12.1 to the battery cell 11. The third embodiment of a high-current spring contact 12 according to the invention in FIG. 6 allows substantially horizontal component and positioning tolerance compensation. According to the invention, further possible embodiments of a high-current spring contact 12 can be of annular or linear design or in the form of a spring-mounted contact pin in a housing.

1. A battery module (10) having a module housing (10.1) and a plurality of battery cells (11) which are arranged in parallel in the module housing (10.1), wherein at least two of the battery cells (11) are mechanically mounted on the module housing (10.1) in each case by at least one bearing element (13), and wherein two of the battery cells (11) which are arranged adjacent to one another are electrically connected to one another by at least one high-current spring contact (12).

2. The battery module (10) according to claim 1, characterized in that the bearing element (13) is a fixed bearing, wherein each battery cell (11) is separately mechanically fixed to the module housing (10.1) in each case by at least one fixed bearing.

3. The battery module (10) according to claim 1, characterized in that the bearing element (13) is a spring element.

4. The battery module (10) according to claim 1, characterized in that the spring contact (12) is arranged on at least one longitudinal side (11.1) and/or broad side (11.2) of the battery cells (11).

5. The battery module (10) according to claim 1, characterized in that the spring contact (12) is cohesively and electrically conductively connected to the battery cell (11).

6. The battery module (10) according to claim 1, characterized in that at least one spacer (14) is arranged between the battery cells (11).

7. The battery module (10) according to claim 1, characterized in that the spring contact (12) has a contact area (12.1) which is of substantially punctiform design.

8. The battery module (10) according to claim 1, characterized in that the spring contact (12) is of at least lamellar, annular, disk-like, spiral or linear design.

9. The battery module (10) according to claim 1, characterized in that the spring contact (12) contains at least tin, nickel, gold, silver or copper.

10. A battery (100) comprising a plurality of battery modules (10) according to claim 1, wherein the battery modules are at least electrically connected to one another.

11. The battery module (10) according to claim 1, characterized in that the bearing element (13) is a spring element, wherein a cell receptacle (15) is provided, in which cell receptacle the battery cells (11) are arranged in parallel in relation to one another and the cell receptacle is mechanically connected to the module housing (10.1) by means of at least one spring element (13).

12. The battery module (10) according to claim 1, characterized in that the spring contact (12) is cohesively and electrically conductively connected to the battery cell (11), wherein the spring contact (12) is formed, at least in sections, from a terminal of the battery cell (11).

13. The battery module (10) according to claim 1, characterized in that at least one spacer (14) is arranged between the battery cells (11), wherein the spacer (14) is formed from the cell housing (11.3) of the battery cell (11).
